(19) United States
(12) Patent Application Publication
(10) Pub. No.: US 2013/0275133 A1
(43) Pub. Date: Oct. 17, 2013

(54) Electronic Pen with Printable Arrangement

(71) Applicant: Dawei Wang, Kingstone, PA (US)

(72) Inventor: Dawei Wang, Kingstone, PA (US)

(21) Appl. No.: 13/917,103

(22) Filed: Jun. 13, 2013

(51) Int. Cl. G10L 15/26

(52) U.S. Cl. CPC G10L 15/265
USPC 704/235

(57) ABSTRACT

An electronic pen includes a voice recognition module for converting voice messages to text messages, a digital scanning model for scanning the content of the digital copy and on the paper, a storage module, an interaction and control module, and a printing module for exporting the content selecting from the electronic pen through a sliding movement on the paper.

### BACKGROUND OF THE PRESENT INVENTION

1. Field of Invention

The present invention relates to a terminal electronic tool pen, and more particularly to an electronic pen which comprises printable arrangement for directly printing the selected content on the paper from the electronic pen through a directly sliding movement on the paper.

2. Description of Related Arts

Conventional electronic pen, according to the current electronic terminal technology, has the advantageous of converting handwritten or printed content directly into digital format for the computer. However, it does not have the function of directly printing content on the paper. Therefore, according to current electronic and printing technology, an electronic apparatus with output device by pushbutton is the necessary demand in the current writing field.

One type of the contemporary technology is able to record human voice and convert into digital format. Another type of the contemporary technology can scan and recognize the content on the paper. Therefore, in order to solve the above mentioned problems, an electronic pen with the combination of the above two contemporary technologies is needed. It may print the selected content from the electronic pen on the paper through a directly sliding movement on the paper. For example, the electronic pen can recognize the human voice and convert into digital format. Therefore, through the voice recognition system of the electronic pen, it recognizes the human voice and converts into digital format, and then prints the content on the paper through a directly sliding movement.

In addition, when filling out forms by hand, such as application forms, it is often not easy to read the scratchy handwriting. Thus, in order to precisely fill the blanks of the application forms with printed format, the electronic pen is able to store the application form, so that to print the content selecting from the electronic pen by printed format through a directly sliding movement on the forms.

### SUMMARY OF THE PRESENT INVENTION

A main advantage of the present invention is to provide an electronic pen, comprising a printable arrangement for printing the content selecting from the electronic pen through a directly sliding movement on the paper.

Another advantage of the invention is to provide an electronic pen, wherein a voice recognition module is provided to convert voice messages into text messages.

Another advantage of the invention is to provide an electronic pen, wherein a digital scanning module is provided to generate scanned content, select the scanning area, and scan for a non-contacting long distance scanning.

Another advantage of the invention is to provide an electronic pen, wherein an interaction and control module is provided to correct the text messages so as to generate corrected text messages, and convert the scanned content into printable text content text document.

Another advantage of the invention is to provide an electronic pen, wherein an interaction and control module is provided to select the font style and font size from font and font size selecting menu.

Another advantage of the invention is to provide an electronic pen, wherein a storage module is provided to store the content of correct text messages and the printable text content.

Another advantage of the invention is to provide an electronic pen, wherein a printing module is provided to selectively print the corrected text messages and printable content through a sliding movement on the paper.

Another advantage of the present invention is to provide an electronic pen, wherein a wireless network module is provided to collect the content on the interne and the content being saved on cloud.

Accordingly, in order to accomplish the above advantages, the present invention provides an electronic pen, which comprising an interaction and control module and a voice recognition module operatively linked with the interaction and control module to convert voice messages into text messages. The interaction and control module is able to correct the content of text messages so as to generate correct text messages. The digital scanning module is operatively linked with the interaction and control module for generating scanned content, wherein the interaction and control module is able to convert scanned content into printable text content. In addition, a storage module is operatively linked with the interaction and control module, wherein the storage module stores the correct text messages and the printable text content. Furthermore, the printing module is operatively linked with the interaction and control module for selectively printing the correct text messages and the printable text message on the paper.

These and other objectives, features, and advantages of the present invention will become apparent from the following detailed description, the accompanying drawings, and the appended claims.

### BRIEF DESCRIPTION OF THE DRAWINGS

FIG. 1 is a system diagram of the electronic pen according to a preferred embodiment of the present invention.

FIG. 2 is a structure diagram of the electronic pen according to a preferred embodiment of the present invention.

FIG. 3 is a paper printed internet network diagram of the electronic pen showing the wireless communication network employed to the electronic pen.

### DETAILED DESCRIPTION OF THE PREFERRED EMBODIMENT

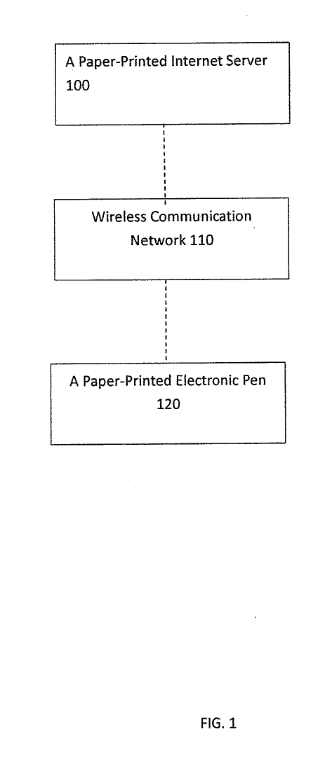

Referring to FIG. 1, a paper-printed internet server 100 is interconnected with a wireless communication network 110, employing the socket of TCP/IP to establish a logical linking connection communicating the content of the message with convention format. In other words, the paper-printed internet server 100 is interconnected with a paper-printed electronic pen 120 via the wireless communication network 110, employing the socket of TCP/IP to establish a logical linking connection communicating the content of the message with convention format.

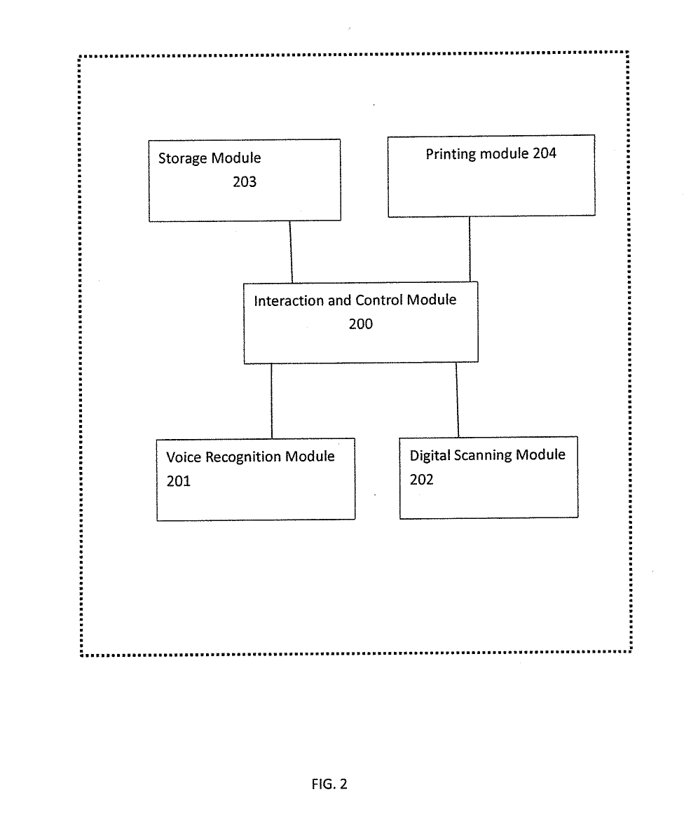

Referring to FIG. 2, the electronic pen comprises an interaction and control module 200, a voice recognition module 201 operatively linked with the interaction and control module 200 to convert voice messages into text messages, a digital scanning model 202 operatively linked with the interaction and control to generate the scanned content, a storage module 203 operatively linked with the interaction and control module, and a printing module 204 operatively linked with the interaction and control module for selectively printing the corrected text messages and printable content through a sliding movement on the paper.

The interaction and control module 200 is arranged to correct the content of text messages to generate the corrected content. In other words, after the content of corrected content being selected to form the selected content, the voice input system opens automatically to collect the voice messages and identify the voice messages forming the identified content, and then the selected content replaces the identified content.

In addition, the interaction and control module 200 is arranged to convert the scanned content into printable content, wherein the digital scanning module 202 of the electronic pen is able to generate the scanned content and then the printable text content is saved in the storage module 203. Moreover, the interaction and control module 200 comprises the font and font size menu to select the font style and font size.

The interaction and control module 200 is further arranged to convert the scanned content into text content, wherein the digital scanning module 202 of the electronic pen is able to generate the scanned content and then the text content is saved in the storage module 203.

Accordingly, the digital scanning module 202 is further provided to select scanning area that is not only by row, but also by region, and scan for non-contacting long distance scanning.

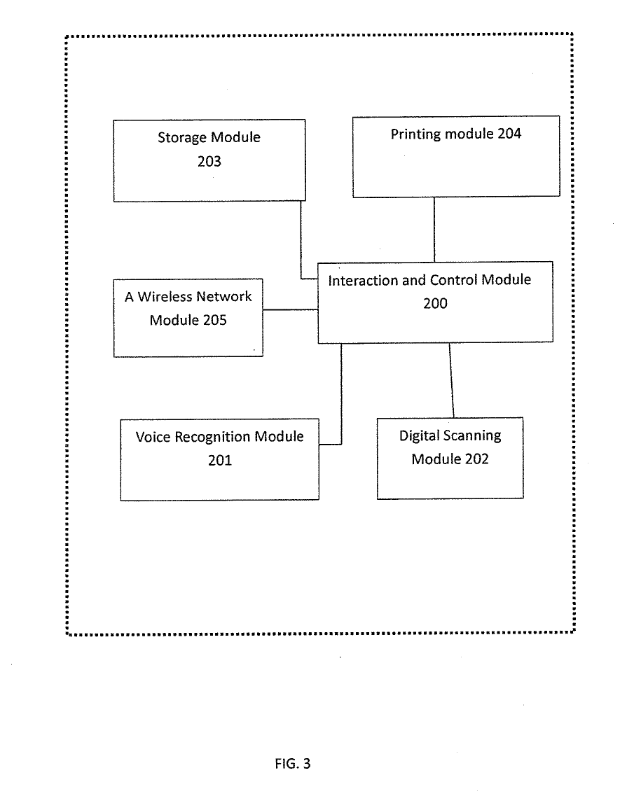

Referring to FIG. 3, the electronic pen further comprises a wireless network module 205 operatively linked with the interaction and control module 200 to collect the content from internet and the document saved on cloud.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic pen, comprising:
an interaction and control module and a voice recognition module operatively linked with said interaction and control module to convert voice messages into text messages, wherein said interaction and control module is able to correct content of said text messages so as to generate correct text messages; and
a digital scanning module operatively linked with said interaction and control module for generating scanned content, wherein said interaction and control module is able to convert said scanned content into printable text content; and
a storage module operatively linked with said interaction and control module, wherein said storage module stores said correct text messages and said printable text content; and
a printing module operatively linked with said interaction and control module for selectively printing said correct text messages and said printable text message on the paper.

2. An electronic pen, as recited in claim 1, wherein said storage module is provided to store said corrected text messages and printable text messages.

3. An electronic pen, as recited in claim 1, wherein said interaction and control module is arranged to correct the text after voice recognition. The voice input system open automatically after the corrected words being selecting, wherein the voice message being collected and identified by said interaction and control module, and then the recognized words replace the selected words.

4. An electronic pen, as recited in claim 1, wherein said interaction and control module is arranged to save scanned content sending from said digital scanning module, wherein said scanned content is converted to the said printable and text content and saves into said storage module.

5. An electronic pen, as recited in claim 1, wherein said interaction and control module further comprises the font and font size menu to select the font style and font size.

6. An electronic pen, as recited in claim 1, wherein said interaction and control module is arranged to save scanned content sending from said digital scanning module, wherein said scanned content is converted to the text format and saves in said storage module.

7. An electronic pen, as recited in claim 1, wherein said digital scanning module is provided to select scanning area that is not only by row, but also by region.

8. An electronic pen, as recited in claim 1, wherein said digital scanning module is provided to scan for long distance non-contacting scanning.

9. An electronic pen, as recited in claim 1, wherein a wireless network module is operatively linking with said interaction and control module to provide the content collection form internet and the document saved on cloud.

10. A method of processing printing content on paper with an electronic pen, comprising the steps of:
(a) converting voice messages into text messages;
(b) correcting said text messages so as to generate corrected text messages; and
(c) printing said corrected text messages on the paper.

11. The method, as recited in claim 10, further comprising a step of saving said corrected text messages.

12. A method of processing printing content on paper with an electronic pen, comprising the steps of:
(a) generating scanned content;
(b) converting said scanned content into printable text content, and
(c) printing said printable text content on the paper.

13. The method, as recited in claim 12, further comprising the step of saving said printable text content.
